(19) United States
(12) Patent Application Publication
(10) Pub. No.: US 2026/0087132 A1
(43) Pub. Date: Mar. 26, 2026

(54) REFINING CURATED QUERIES

(71) Applicant: Arctic Wolf Networks, Inc., Eden Prairie, MN (US)

(72) Inventors: Brian Wilson Boon, Lincoln, NE (US); Kenneth D. Ray, Enumclaw, WA (US); Marcio Lopes Larroyd, Kitchener (CA); Michael Elliott Mylrea, Delray Beach, FL (US); Zaahid Muhammad, Minneapolis, MN (US); Warren Christopher Gray, Kitchener (CA)

(21) Appl. No.: 19/206,268

(22) Filed: May 13, 2025

Related U.S. Application Data
(60) Provisional application No. 63/646,031, filed on May 13, 2024.

(51) Int. Cl. G06F 21/55; G06F 21/57

(52) U.S. Cl. CPC G06F 21/554; G06F 21/577

(57) ABSTRACT

Disclosed are techniques and technology for fine-tuning a cybersecurity event response. A method can include receiving, by a computer system, analysis history data associated with the cybersecurity event response and a security outcome of user actions performed in the cybersecurity event response, identifying behavior patterns based on the analysis history data, generating a value for the cybersecurity event response that can correspond to the security outcome of the user actions performed in the cybersecurity event response and the identified behavior patterns, determining at least one suggestion for fine-tuning the cybersecurity event response based on the value for the cybersecurity event response, and returning the at least one suggestion for fine-tuning the cybersecurity event response.

### INCORPORATION BY REFERENCE

This application claims the priority benefit of U.S. Provisional Patent Application No. 63/646,031, filed May 13, 2024, the entirety of which is incorporated herein by reference.

### TECHNICAL FIELD

This disclosure generally describes devices, systems, and methods related to automated and artificial intelligence (AI)-based techniques for identifying value and fine-tuning parameters according to the value, such as for refining and curating queries in a cybersecurity environment.

### BACKGROUND

Real-world cybersecurity threat landscapes, as well as user environments, may evolve over time. New vulnerabilities emerge as internet of things (IoT), cloud computing, and/or AI present new attack vectors that bad actors may exploit. With greater complexity and interconnectivity of devices and systems, an attack surface expands, providing potential opportunities for cyber exploitation. Moreover, cyber attackers may continuously improve and automate their tactics, techniques, and procedures (TTPs) by using techniques such as AI and/or machine learning (ML). Such advanced tools can make the cybersecurity attacks more challenging to detect, mitigate, and/or resolve.

The constant change makes it challenging to evaluate usefulness and value of remedial investigations as they are scaled to address cybersecurity threats and meet the needs of the user environments. As a result, investigations of cybersecurity incidents may be inconsistent and/or inadequate to resolve threats posed by those incidents. Runbooks, or other types of documentation detailing step-by-step procedures for addressing different cybersecurity issues and/or incidents may have limited coverage over the constantly evolving threat landscape. Analysts and other relevant users who may perform the investigations can have varied skills and expertise, which may affect an overall ability to adequately resolve the threats posted by the cybersecurity incidents as the landscape continues to evolve. Similarly, identification and documentation of expected practices for threat detection, investigation, and/or resolution may not scale quickly enough to the ever-changing threat environment.

### SUMMARY

The disclosure generally describes technology and techniques for identifying “value” of investigative steps and refining processes and parameters of those steps based on the identified value. In the context of cybersecurity, “value” can be related to a security outcome provided by a cybersecurity environment (such as value provided to its customers). Value can be in the form of, but is not limited to, proof that a customer of the cybersecurity environment is safe from cybersecurity threats, action(s) performed by the cybersecurity environment to improve the customer's stance on cybersecurity, action(s) performed by the customer at a recommendation of the cybersecurity environment that improves the customer's stance on cybersecurity, or prevention, discovery, or remediation of a security breach based on findings by the cybersecurity environment. Various other definitions of value are also possible, and can vary based on an industry, scenario, and/or use case in which the disclosed techniques are applied.

More particularly, the disclosed techniques can be used to refine and/or curate queries in a cybersecurity context. The disclosed techniques can provide for refining ways that analysts interact with cybersecurity systems, how responses and events are classified, analysts' event responses, and/or recommendations for responding to various types of cybersecurity events. For example, the disclosed techniques can refine immediate next actions to take during a cybersecurity event, queries themselves, and/or how to respond to the queries. Queries can include but are not limited specific steps of an investigation, as discussed further herein. Queries can be curated or prioritized to understand their contexts, and then refined to provide improved queries to cybersecurity analysts for use during investigations of cybersecurity events. For example, for every query that an analyst creates or calls to investigate an event, campaign, and/or piece of evidence, the disclosed techniques can be used to determine and/or quantify how valuable that query may be. Frequently run queries may be indicators of areas on which to focus (e.g., for new or tuned detections, for enrichment of evidence and/or events, for automation to improve metrics). The contexts can indicate information that is known about cybersecurity event cases before an analyst starts working on those cases. The contexts can be grouped together using the disclosed techniques by predicting actions needed by the analyst to investigate each of the cases. The context groupings may evolve over time, as cybersecurity threats evolve and/or analyst response actions evolve. In some implementations, the groupings may be changed over time using AI and/or machine learning models that are trained against actual actions taken by the analyst to resolve or otherwise address the cybersecurity events. Refining the queries and providing the refined queries using the disclosed techniques can improve the ability of analysts to adequately address, mitigate, and/or investigate the cybersecurity events in an ever-changing cybersecurity environment. In other words, illustrative embodiments and implementations described herein can enrich the value of an analyst's investigative steps.

To provide a feedback mechanism in which refined queries are provided to the analysts, a combination of metrics aligned with detections and natural language questions/queries that are executed against the detections may be processed. Such metrics can capture subjective qualitative feedback such as a decision by the analyst to ticket or not ticket a cybersecurity event, as a decision to close the cybersecurity event or customer (e.g., user) feedback. Additionally, objective quantitative feedback metrics may also be used to contribute to identifying value of the queries. Such quantitative feedback metrics may include but are not limited to time spent and compute cost. Any of these metrics may be assessed for the cybersecurity event using the disclosed techniques to glean value associated with one or more queries related to the event and further refine those queries. Leveraging both qualitative and quantitative feedback using automated techniques and AI can advantageously and continuously improve value, performance, and accuracy of the queries used in response to the cybersecurity events.

One or more embodiments described herein can include a method for fine-tuning a cybersecurity event response, the method including: receiving, by a computer system, analysis history data associated with the cybersecurity event response and a security outcome of user actions performed in the cybersecurity event response, identifying, by the computer system, behavior patterns based on the analysis history data, generating, by the computer system, a value for the cybersecurity event response, the value corresponding to the security outcome of the user actions performed in the cybersecurity event response and the identified behavior patterns, determining, by the computer system, at least one suggestion for fine-tuning the cybersecurity event response based on the value for the cybersecurity event response, and returning, by the computer system, the at least one suggestion for fine-tuning the cybersecurity event response.

The method can optionally include one or more of the following features. For example, the at least one suggestion can include a recommendation for refining an immediate next action to take in response to a cybersecurity event. The at least one suggestion can include a recommendation for refining one or more queries that may be used to investigate context around a cybersecurity event. The at least one suggestion can include a recommended response for addressing a cybersecurity event. The analysis history data can include queries that were executed in response to investigating one or more cybersecurity events.

Sometimes, generating, by the computer system, the value for the cybersecurity event response can include applying artificial intelligence (AI) techniques to the security outcome of the user actions and the identified behavior patterns. The AI techniques can be trained to correlate the security outcome, the user actions, and the behavior patterns to determine numerical values of one or more actions in the cybersecurity event response that correspond to the value for the cybersecurity event response. As another example, determining, by the computer system, the at least one suggestion for fine-tuning the cybersecurity event response can include applying AI techniques to the determined value to generate the at least one suggestion. The AI techniques can be trained to correlate the determined value for the cybersecurity event response with actions in the cybersecurity event response to generate the at least one suggestion that, when executed in response to a cybersecurity event, maintains or improves the determined value for the cybersecurity event response.

One or more embodiments described herein can include a method for generating suggestions in a cybersecurity environment, the method including: receiving, by a computer system, an indication of compromise in a computer network, receiving, by the computer system and based on the indication of compromise, analysis history data of responses to the indication of compromise, the analysis history data including queries that were executed to respond to the indication of compromise, determining, by the computer system and based on processing the analysis history data and the indication of compromise, a value of the queries, generating, by the computer system and based on (i) the value of the queries and (ii) a context of a cybersecurity risk associated with the indication of compromise, one or more cybersecurity response suggestions, and returning, by the computer system, the one or more cybersecurity response suggestions.

The method can optionally include one or more of the following features. For example, the indication of compromise can include environmental metadata under which the cybersecurity risk was detected in the computer network. The value of the queries can be determined, by the computer system, within a context of a detected cybersecurity risk that may be associated with the indication of compromise. Determining, by the computer system and based on processing the analysis history data and the indication of compromise, the value of the queries further can include measuring a usefulness of the queries based on a security outcome from executing the queries. Sometimes, determining, by the computer system and based on processing the analysis history data and the indication of compromise, the value of the queries further can include measuring a cost of the queries based on a security outcome from executing the queries. As another example, determining, by the computer system and based on processing the analysis history data and the indication of compromise, the value of the queries further can include measuring time spent on the queries based on a security outcome from executing the queries. Sometimes, determining, by the computer system and based on processing the analysis history data and the indication of compromise, the value of the queries can include inferring time spent on the queries based on a security outcome from executing the queries.

One or more embodiments described herein can include a method for generating query suggestions in a cybersecurity environment, the method including: collecting, by a computer system, analyst actions, queries executed, and security outcomes within a context of an indication of compromise in a computer network, calculating, by the computer system, a value of each of the queries based on processing the analyst actions and the security outcomes, ranking, by the computer system, the queries based on the calculated value for each of the queries, generating, by the computer system and based on the ranking, suggestions for improving the queries, and returning, by the computer system, the suggestions for execution.

The method can optionally include one or more of the following features. For example, calculating, by the computer system, the value of each of the queries further can include applying AI techniques to the analyst actions and the security outcomes. The AI techniques can be trained to correlate the analyst actions and the security outcomes with numerical values that indicate a quantitative value associated with each of the queries that corresponds to an improved security outcome. Sometimes, the queries can be ranked from highest value to lowest value. The highest value can indicate a query needing most improvement and the lowest value can indicate a query needing least improvement amongst the queries. The suggestions can include queries to be asked or executed in response to subsequent cybersecurity events. Sometimes, the method can include returning the suggestions for presentation in a user interface (UI) at a computing device. The analyst actions can include actions performed by an analyst using UI features presented at a computing device for responding to a cybersecurity event in the computer network.

One or more embodiments described herein can include a method for identifying value to fine-tune a process, the method including: receiving, by a computer system, analysis history data associated with the process and an outcome of user actions performed in the process, identifying, by the computer system, behavior patterns based on the analysis history data, generating, by the computer system, a value for the process based on the outcome of the user actions performed in the process and the identified behavior patterns, determining, by the computer system, at least one suggestion for fine-tuning the process based on the generated value for the process, and returning, by the computer system, the at least one suggestion for use in fine-tuning the process.

In some implementations, the embodiments described herein can optionally include one or more of the following features. For example, the process can include a cybersecurity event response. The analysis history data can include queries that were asked or executed by a user in response to investigating the cybersecurity event. The at least one suggestion can include reducing a value for a query or an action of the process performed by a user in response to investigating the cybersecurity event or other cybersecurity events. The at least one suggestion can include updating a value of a cybersecurity event detection rule. The at least one suggestion can include a recommendation to automate one or more operations in the process. Sometimes, generating, by the computer system, the value for the process can include applying artificial intelligence (AI) techniques to the outcome of the user actions performed in the process and the identified behavior patterns. The AI techniques can be trained to correlate the outcome, the user actions, and the behavior patterns to determine numerical value of one or more operations or actions in the process. Sometimes, determining, by the computer system, the at least one suggestion for fine-tuning the process can include applying AI techniques to the determined value, the AI techniques having been trained to correlate the determined value with operations or actions in the process to perform to maintain or improve the determined value.

One or more embodiments described herein may include a method for determining suggestions in a cybersecurity environment, the method including: receiving, by a computer system, an indication of compromise in a computer network, receiving, by the computer system and based on the indication of compromise, analysis history data of a user responding to the indication of compromise, the analysis history data including queries asked or executed by the user, determining, by the computer system and based on processing the analysis history data and the indication of compromise, a value of the queries asked or executed by the user, generating, by the computer system and based on (i) the value of the queries asked or executed by the user and (ii) a context of a cybersecurity risk associated with the indication of compromise, one or more query suggestions, and returning, by the computer system, the one or more query suggestions.

In some implementations, the method can optionally include one or more of the above features and/or one or more of the following features. For example, the indication of compromise can include a detected cybersecurity risk in the computer network. The indication of compromise can include environmental metadata under which a cybersecurity risk was detected in the computer network. The value of the queries asked or executed by the user can be determined, by the computer system, within a context of a detected cybersecurity risk associated with the indication of compromise. Sometimes, determining, by the computer system and based on processing the analysis history data and the indication of compromise, the value of the queries asked or executed by the user further can include measuring a usefulness of the queries asked or executed based on an outcome of asking or executing the queries. Determining, by the computer system and based on processing the analysis history data and the indication of compromise, the value of the queries asked or executed by the user further may include measuring a cost of the queries asked or executed based on an outcome of asking or executing the queries. Determining, by the computer system and based on processing the analysis history data and the indication of compromise, the value of the queries asked or executed by the user may include measuring time spent on the queries that were asked or executed based on an outcome of asking or executing the queries. Determining, by the computer system and based on processing the analysis history data and the indication of compromise, the value of the queries asked or executed by the user further can include inferring time spent on the queries that were asked or executed based on an outcome of asking or executing the queries.

One or more embodiments described herein can include a method for generating query suggestions in a cybersecurity environment, the method including: automatically collecting, by a computer system, analyst actions, queries asked, and security outcomes within a context of an indication of compromise in a computer network, automatically calculating, by the computer system, a value of each of the queries asked based on processing the analyst actions and the security outcomes, automatically ranking, by the computer system, the queries asked based on the calculated value for each of the queries asked, generating, by the computer system and based on the ranking, one or more suggestions for improving the queries asked, and returning, by the computer system, the one or more suggestions.

In some implementations, the method may optionally include one or more of the above features and/or one or more of the following features. For example, automatically calculating, by the computer system, the value of each of the queries asked based on processing the analyst actions and the security outcomes can include applying AI techniques to the analyst actions and the security outcomes. The AI techniques can be trained to correlate the analyst actions and the security outcomes with numerical values that indicate a quantitative value associated with each of the queries asked.

One or more embodiments described herein may include a method for improving efficiency of cybersecurity analysts, the method including: presenting, at an analyst computing device, a user interface (UI) with UI features for responding to a cybersecurity event, receiving, from the analyst computing device, analysis history data, the analysis history data having been collected using the UI features in the UI at the analyst computing device, the analysis history data indicating actions performed by an analyst using the UI features in the UI to respond to the cybersecurity event, identifying behavior patterns based on processing the received analysis history data, generating, based on the identified behavior patterns, suggested actions to be performed by the analyst to respond to the cybersecurity event, and presenting, at the analyst computing device, the generated suggested actions during a resolution phase of the cybersecurity event, the generated suggested actions being presented in the UI at the analyst computing device.

In some implementations, the method may optionally include one or more of the above features and/or one or more of the following features. For example, the suggested actions can include queries to ask or execute. The analysis history data can indicate queries asked or executed by the analyst. In response to generating the suggested actions, the method further may include: providing the suggested actions to a subject matter expert computing device, receiving, from the subject matter expert computing device, user input indicating a quality of each of the suggested actions, selecting one or more of the suggested actions based on the user input indicating the respective quality, and presenting, at the analyst computing device, the selected one or more suggested actions in the UI at the analyst computing device. Identifying the behavior patterns may include identifying efficient behavior patterns and wasteful behavior patterns, and the suggested actions may be generated based on the efficient behavior patterns.

One or more embodiments described herein can include a method for generating query suggestions for resolving cybersecurity events in a cybersecurity environment, the method including: presenting, by a computer system and at an analyst computing device, a UI with UI features for responding to a detected cybersecurity event, receiving, by the computer system and from the analyst computing device, analysis history data and cybersecurity events data, the analysis history data having been collected using the UI features and query handlers at the analyst computing device, the analysis history data indicating queries asked or executed by an analyst using the UI features in the UI to respond to the detected cybersecurity event, identifying, by the computer system, behavior patterns of the analyst based on processing the received analysis history data, calculating, by the computer system, a value of each of the queries asked or executed by the analyst based at least in part on the identified behavior patterns and the cybersecurity event data, generating, by the computer system, suggested queries to be asked or executed by the analyst to respond to the cybersecurity event based at least in part on the determined value of each of the queries asked or executed by the analyst, and presenting, by the computer system and at the analyst computing device, the suggested queries in the UI.

In some implementations, the method may optionally include one or more of the above features and/or one or more of the following features. For example, the method further may include applying, by the computer system, AI techniques to (i) the identified behavior patterns of the analyst and (ii) the cybersecurity event data to calculate the value of each of the queries. The method may include applying, by the computer system, AI techniques to (i) the value of each of the queries and (ii) the cybersecurity event data to generate the suggested queries. The method can include ranking, by the computer system, the queries based on the respective value of each of the queries. The queries can be ranked from highest value to lowest value. The highest value can indicate a query needing the most improvement and the lowest value can indicate a query needing the least improvement amongst the queries. The method may also include generating, by the computer system, the suggested queries based on the ranked queries.

The devices, system, and techniques described herein may provide one or more of the following advantages. For example, the disclosed techniques can reduce work and effort required of the cybersecurity analysts to investigate and respond to cybersecurity events. The disclosed techniques can automate the investigation process using AI and/or machine learning models, thereby providing the analysts with robust information, additional context, response recommendations, and/or curated queries related to each of the cybersecurity events. The disclosed AI-based techniques and feedback loops can also improve accuracy and consistency of investigation outcomes. Similarly, the disclosed techniques may improve analyst efficiency by reducing time spent to look for answers in response to the cybersecurity events. The techniques described herein can provide for automated data gathering and presentation to the analysts, which can then be used by the analysts to more efficiently identify answers and remediation tactics for the cybersecurity events. Moreover, the disclosed techniques may reduce computing time and/or computing resources used by eliminated analysis and further process of low-value, unnecessary queries/questions.

To provide robust and value-based insight in a cybersecurity environment, the disclosed technology can use a complex collection of algorithms, AI, and/or machine learning techniques to analyze data related to at least one parameter (e.g., queries) for one or more cybersecurity events to provide the analysts with curated queries and refined response recommendations. This complex collection of algorithms, AI, and/or machine learning techniques can provide an unconventional solution to the problem of trying to identify value and refine processes for addressing cybersecurity events in an ever-changing cybersecurity threat landscape. This unconventional solution can be rooted in technology and provides information that was not available in conventional systems. This unconventional solution also represents an improvement in the subject technical field otherwise unrealized by conventional systems. Specifically, unlike conventional systems, the disclosed technology may continuously and automatically capture and analyze different types of analyst actions in response to constantly changing types of cybersecurity events to provide curated and refined queries and responses for the analysts to implement when responding to future cybersecurity events.

After the disclosed technology identifies value and generates refined queries and responses, the disclosed technology can display relevant information and data using a GUI on a display of computing devices of the analysts in a unique and easy to understand format. Conventional systems may not provide the disclosed solutions for at least the following reasons: (i) the significant processing power required to automatically capture and assess analyst actions in response to a cybersecurity event investigation, (ii) the significant processing power required to automatically refine and curate queries and responses based on the assessment of the analyst actions, (ii) the considerable data storage requirements for maintaining information collected and determined by the disclosed technology, (iii) a large enough pool of parameter data to provide accurate thresholds and other criteria for the disclosed algorithms, AI, and/or machine learning techniques, (iv) algorithms, AI, and/or machine learning techniques that allow for the thresholds and/or other criteria to be self-updated in light of additional data that can be added to the pool of relevant parameter data, (v) other hardware and software features discussed below, and/or (vi) other reasons relevant to the disclosed technology.

The complex collection of algorithms, AI, and/or machine learning techniques can be operationally linked and tied to the disclosed technology, which ensures that the disclosed algorithms, AI, and/or machine learning techniques may not preempt all uses of these techniques beyond the disclosed technology. In addition, the GUI displays results of the execution of these complex algorithms, AI, and/or machine learning techniques in a manner that can be easily understandable by a human user, viewed on a small or handheld screen, and/or in such a way that improves operation of computing devices, etc. Additionally, translation of outcomes from these complex algorithms, AI, and/or machine learning techniques through the GUI onto information displayed for the analyst improves comprehension of considerable quantities of highly processed data. For example, an exemplary algorithm from this complex collection of algorithms can require: capturing actions data (e.g., analysis history data) using query handlers and/or user interface (UI) inputs from many analyst computing devices, selecting some data provided by the analyst computing devices, ignoring some of the data that was provided by the analyst computing devices, performing multiple calculations on a selected subset of the data, combining the data from these multiple calculations and then outputting that data within a short amount of time (e.g., preferably less than a minute, in real-time, in near real-time), all for potentially many analysts or other relevant users.

Moreover, the exemplary techniques, algorithms, AI, and/or machine learning techniques cannot be performed with a pen and paper or within the human mind because such techniques may require analyzing millions of data points to find similarities amongst cybersecurity events and responses, identifying value in queries and/or the responses, refining and curating queries and responses based on the identified value, generating and outputting recommendations including the curated queries and/or responses to relevant users, such as the analysts, and repeating one or more of such operations over one or more continuous periods of time and for many different types of cybersecurity events and//or cybersecurity environments.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a system for assessing analyst actions data in response to a cybersecurity event and generating curated queries based on the assessment.

FIG. 2A is a conceptual diagram of a process having a feedback loop for generating curated queries in a cybersecurity environment.

FIG. 2B is a block diagram illustrating a curation loop for generating curated queries as described herein.

FIG. 3 is a conceptual diagram of a system for generating, presenting, and/or executing curated queries in a cybersecurity environment.

FIG. 4 is a conceptual diagram of a process for responding to an evidence task in a cybersecurity environment.

FIG. 5 illustrates an example GUI for presenting curated queries at an analyst computing device.

FIG. 6 is a flowchart of a process for generating suggested queries in a cybersecurity environment.

FIG. 7 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to technology and techniques to identify value and fine tune parameters and/or processes based on the identified value. More particularly, the disclosed techniques can be used to fine tune or otherwise curate queries for cybersecurity events in a cybersecurity environment. The disclosed techniques can be used to fine tune detection of the cybersecurity events. The disclosed techniques may otherwise be used to improve overall value in processes for investigating and responding to the cybersecurity events. In some implementations, the disclosed techniques may leverage AI techniques to identify value and fine tune parameters and/or processes described herein.

As an illustrative example, the disclosed techniques can collect and analyze analyst responses to cybersecurity event tickets. Based on the analysis, the disclosed techniques can leverage AI and/or classification techniques to identify value and determine valuable queries to provide analysts for use in responding to the cybersecurity event tickets. Similarly, the disclosed techniques can provide for automated predictive curation of various steps for investigating security event tickets, which can include the predictive curation of queries for investigating said tickets, which is described further in reference to U.S. Patent Application No.______ entitled TECHNOLOGIES FOR AUTOMATED PREDICTIVE CURATION OF CONTEXTUALIZATION STEPS FOR INVESTIGATING A SECURITY INCIDENT, which was filed on even date herewith, and which is incorporated herein by reference in its entirety. Sometimes, the actions performed for addressing the tickets can be performed through a cybersecurity interface as described in U.S. patent application Ser. No.______, entitled CYBERSECURITY INTERFACE FOR RESPONSE AND MITIGATION, which was filed on even date herewith, and which is incorporated herein by reference in its entirety. The disclosed techniques may further include providing the determined queries to computing devices of the analysts for use in addressing current cybersecurity event tickets and/or future cybersecurity event tickets. One or more feedback loops may be used to identify value and determine curated queries. Some of the feedback loops may be nested or otherwise configured to loop through each other.

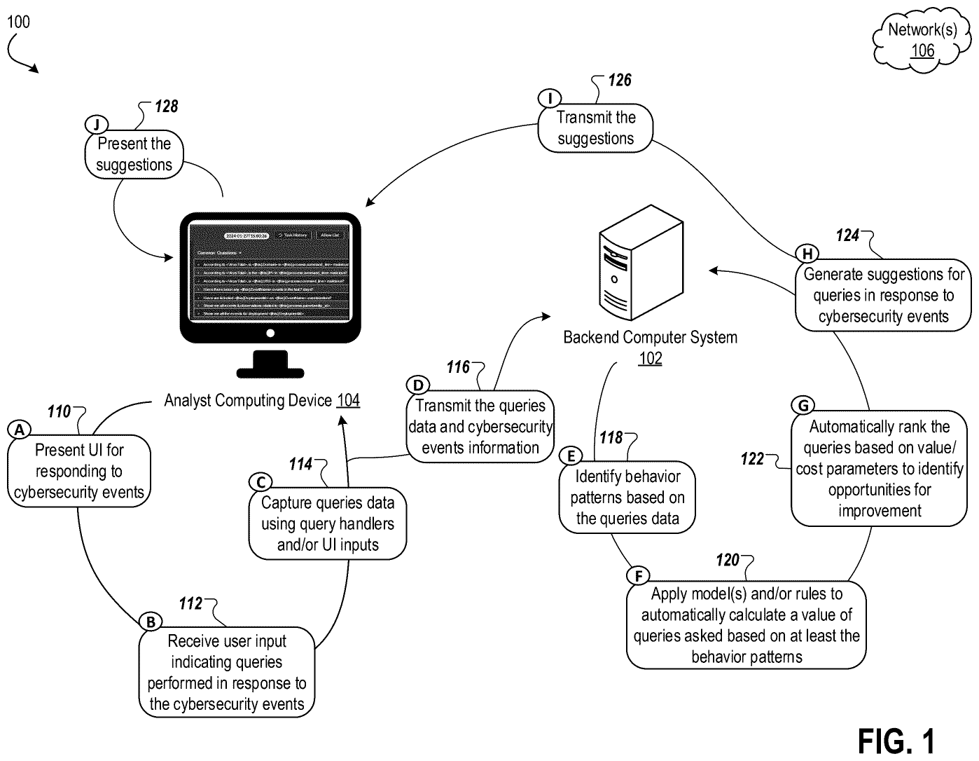

Referring to the figures, FIG. 1 is a conceptual diagram of a system 100 for assessing analyst actions data, such as queries asked by the analyst, in response to a cybersecurity event and generating curated queries based on the assessment. In the example system 100, a backend computer system 102 and an analyst computing device 104 can communicate with each other (e.g., wired, wireless) via network(s) 106. The backend computer system 102 can be any type of computing system, cloud-based system, and/or network of computing devices and/or systems configured to process actions data generated at/provided by the analyst computing device 104 to identify value and generate curated queries for cybersecurity events. The backend computer system 102 may perform operations for improving efficiency of cybersecurity analysts by generating suggestions for investigating and/or responding to the cybersecurity events, the suggestions including one or more curated queries. The suggestions may also expedite requests to respond to/investigate cybersecurity events by guiding the analyst based on efficient patterns of behavior identified from past interactions and actions taken in response to other cybersecurity events.

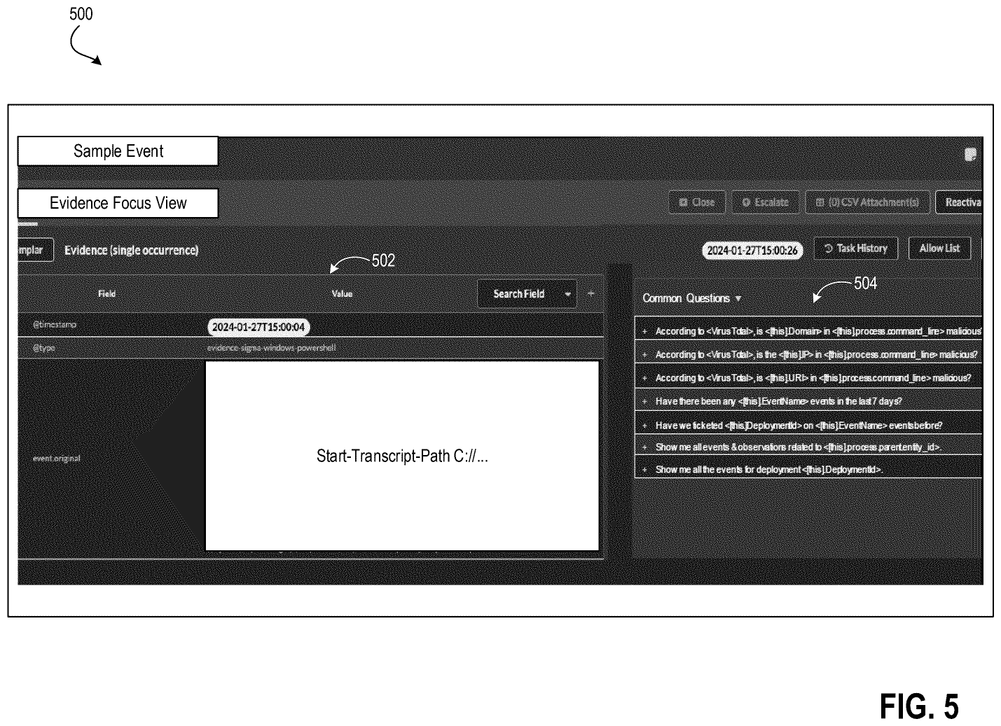

The analyst computing device 104 can be any type of user device, mobile device, smartphone, laptop, computer, tablet, etc. The analyst computing device 104 can be used by an analyst in a cybersecurity environment to address, respond to, and/or investigate cybersecurity events, such as potential cybersecurity threats, attacks, etc. The analyst computing device 104 can present information from the backend computer system 102 in one or more GUIs displayed at the device 104. The information may include dashboards and other interfaces for viewing information and addressing the cybersecurity events that are detected (such as detected by the backend computer system 102 and/or detected by another user/customer security system/computing environment). As an illustrative example, the information can include a dashboard identifying cybersecurity events that have been detected over a predetermined period of time. The analyst can review the events and select one or more of the events for which to open a ticket (if the ticket has not already been opened). The ticket may indicate that the particular event is being investigated. Once the ticket is opened, the analyst can perform one or more actions at the analyst computing device 104 to investigate and respond to the particular event having the ticket. The GUIs described herein may include instrumentation to track actions performed by the analyst while investigating and/or responding to the particular event. Refer to FIG. 5 for further discussion about an example GUI for presenting information about a cybersecurity event at the analyst computing device 104.

Still referring to FIG. 1, the analyst computing device 104 can present a UI (e.g., GUI) for responding to cybersecurity events in block A (110). As described above and throughout this disclosure, the UI can include selectable features, elements, and/or visual information about cybersecurity events that are detected in a cybersecurity environment. The device 104 may receive user input indicating selection of a cybersecurity event in the UI. Selection of the event can cause the device 104 to present, in the same UI or in a different UI, additional information about the selected event. As a result, the analyst may provide additional input at the device 104 in order to investigate and/or respond to the selected cybersecurity event.

As mentioned above, the analyst computing device 104 can receive user input indicating queries or other types of actions performed in response to the cybersecurity events presented in the UI (block B, 112). The actions can include actions that the analyst takes while investigating the cybersecurity event, or actions to respond to, clear, or otherwise mitigate the cybersecurity event. For example, the analyst may submit queries including but not limited to IP address analysis, domain analysis, file hash analysis, network traffic analysis, user activity analysis, endpoint analysis, incident response coordination, threat intelligence queries, vulnerability assessment, and/or policy/compliance checks. Various other types of queries are also possible.

The analyst computing device 104 can capture query data (e.g., actions data) using query handlers and/or UI inputs in block C (114), which can be configured to automatically and implicitly capture behavior,. The captured query data may include, but is not limited to, the analyst's actions, queries or questions that the analyst asked while investigating and/or responding to the cybersecurity event, and/or security outcomes within the context of an indication of cybersecurity event compromise at the analyst computing device 104.

The query data and/or the cybersecurity events information can be transmitted from the analyst computing device 104 to the backend computer system 102 in block D (116). The transmitted data may include information about the cybersecurity event, any queries and/or questions that may have been posed/asked by the analyst at the device 104, one or more outcomes within the context of an indication of compromise of the cybersecurity event. In some implementations, the device 104 may transmit only the collected query data to the backend computer system 102 since the backend computer system 102 may already have access to the cybersecurity events information. The data can be transmitted in block D (116) in real-time or near real-time, such as while the analyst is performing actions in response to the cybersecurity event. In some implementations, the data can be transmitted in batch processes and/or at predetermined time intervals. For example, the data can be transmitted once the analyst provides user input to indicate closure or resolution of the cybersecurity event. As another example, the data can be transmitted once the analyst has completed one or more operations or milestones in a process of investigation (e.g., the analyst completed an initial level of investigation, the analyst asked queries or questions based on the investigation, the analyst finished the investigation but has not yet asked queries or questions as a next step). As yet another example, the data can be transmitted at predetermined time intervals, such as every 5 minutes, every 10 minutes, every 30 minutes, every hour, every 12 hours, every 24 hours, etc.

Using the collected information, the backend computer system 102 can identify behavior patterns (block E, 118). The behavior patterns can be determined based on processing the query data to establish a link between (i) the full context of the investigation up to a certain point in time (e.g., a current or present moment in time) as feature vectors and (ii) next steps regarding the cybersecurity event, or the queries performed by the analyst. Sometimes, the backend computer system 102 can access data sources to retrieve additional data for use in identifying behavior patterns. For example, the backend computer system 102 can retrieve, from a data store, historic queries, analyst actions, and/or cybersecurity events data that may be similar to the metrics currently being assessed. As another example, the backend computer system 102 can retrieve, from one or more network computing systems and/or the data store, network traffic data from a time period associated with the cybersecurity event, such as when the cybersecurity event was detected. The backend computer system 102 can also retrieve network traffic data indicating activities or actions being performed by the analyst at or around the time period at which the cybersecurity event was detected.

The behavior patterns can be determined using techniques including but not limited to machine learning models and algorithms. The machine learning can be used within context of the particular cybersecurity event. An initial context can be detection. Over time, a given detection can have a set of actions and/or queries associated with it. From the set of actions and/or queries gathered within the context over time, a pattern or set of patterns may emerge. Over time, as the context evolves, and a threat landscape evolves, the pattern(s) may also evolve, especially as the analyst behavior patterns change to respond to the threat landscape and/or the cybersecurity event.

The behavior patterns can be used to determine value of the queries. The behavior patterns may also be used to determine what types of questions or next steps the analyst has taken in response to the cybersecurity event and/or what questions or next steps they should take moving forward (with the current event or other events). In some implementations, the backend computer system 102 can identify behavior patterns of each individual, then aggregate the individual behavior patterns to determine aggregate analyst behavior patterns. The aggregate behavior patterns can be used to glean insight into questions/queries that are most valuable to the aggregate of analysts.

The backend computer system 102 may also apply one or more AI and/or machine learning models and/or rulesets to automatically calculate a value of queries (individual queries, combinations of queries) based on at least the behavior patterns (block F, 120). In some implementations, the backend computer system 102 can calculate the value of the queries using statistical models rather than AI and/or machine learning models and algorithms. For example, to compute the value of a query or a set of queries, the value can be associated with positive and negative outcomes, such as closure reasons. Some closure reasons may be considered positive while others may be considered negative. Example closure reasons include but are not limited to: something known about an environment of the customer indicates that the event is not a true positive for the customer (e.g., analyst notes, customer-specific suppression rules, anti-escalation), a global analyst note to close a detection of the event based on what is being seen with the event/detection, a spike where a detection goes off the rails and needs to be closed, when there is mitigating evidence indicating that the event was not a true positive, a subsequent event indicated that an initial indicator has been cleaned up, closing based on a runbook, insufficient evidence for escalation, and/or when detection tuning is necessary (e.g., when a rule does not provide enough value).

In some implementations, the AI and/or models can receive the behavior patterns as inputs, then process the inputs to generate output indicating numerical values of queries corresponding to the behavior patterns. In some implementations, additional inputs can be provided to the AI and/or models, including but not limited to other analyst actions, outcomes from the analysts' actions and/or queries asked, or any combination thereof. In some implementations, a classifier can be trained to calculate the value of the queries. During runtime, the backend computer system 102 can generate a maximum value for each query or a group/set of queries. During runtime, the backend computer system 102 can also predict costs associated with analyzing and/or addressing a cybersecurity event of each type. Those costs can include but are not limited to time spent, monetary costs, value to a customer, value to the cybersecurity environment, etc.

The backend computer system 102 may automatically rank the queries based on the respective value and/or cost parameters to identify areas of opportunity for improvement (block G, 122). For example, the backend computer system 102 can compare the numeric values of the queries against each other to rank from highest to lowest value. Some queries can be identified/quantified as very costly (e.g., high numeric value assigned as a cost), but the analyst can determine that the high cost is acceptable because those queries are very valuable. The opposite may also occur where a query is not costly (e.g., low numeric value assigned as a cost), but also is of low value. In order to determine what to tune or eliminate, the backend computer system 102 may compute a ratio of value:cost. Queries having a ratio that trends towards 0 can be tuned and/or eliminated.

As another example, the backend computer system 102 can compare the numeric values of the queries (or the ratio of value:cost described above) against a predetermined threshold value and/or range. In some implementations, a higher numeric value can indicate an opportunity for improvement whereas a lower numeric value can indicate less of an opportunity for improvement. As described above, the ratio of value:cost that trends towards/closer to 0 can indicating an opportunity for improvement and/or an opportunity for eliminating the corresponding query altogether. Opportunities for improvement correspond to queries that can be modified or otherwise refined in order to provide greater value to the analyst in responding to and resolving a cybersecurity event. A query having a lower numeric value can include a query that is currently providing at least a threshold amount of value to the analyst in responding to/resolving the cybersecurity event, to the customer, and/or to the cybersecurity environment more generally.

In block H (124), the backend computer system 102 may generate suggestions for actions and/or queries in response to the current and/or future cybersecurity events. As described above, the backend computer system 102 may determine a ratio of value:cost for each query and select queries having a ratio trending towards 0 or within a threshold range of 0. The backend computer system 102 can generate suggestions for improving and/or eliminating those selected queries. The backend computer system 102 can generate suggestions for refining queries that have certain rankings in block G (122). As an illustrative example, top 5 ranked queries can be used by the backend computer system 102 to generate refined queries as the suggestions. In some implementations, generating the suggestions may include refining a calculation of value for a particular query or other user action. Refining the calculation of the value for the particular query or other action can include reducing a scored value of the particular query or the other action. As another example, the backend computer system 102 can generate suggestions for refining queries having respective values that satisfy threshold values and/or criteria in block F (120).

The suggestions may be generated by analyzing the analyst actions. The suggestions can be generated to improve overall value to the analyst, the customer, and the cybersecurity environment more generally. The suggestions can further be generated to make the analyst more efficient in addressing similar or different/other cybersecurity events in the future. In some implementations, the suggestions can be generated while a cybersecurity event is still open and in the process of investigation/resolution by the analyst. As a result, the backend computer system 102 can generate suggestions for next steps that the analyst can perform to resolve the cybersecurity event. In some implementations, the backend computer system 102 can generate suggestions for investigating and/or resolving other, future cybersecurity events.

Although the suggestions are described herein to generate refined queries for the analyst to use in resolving the cybersecurity event, the backend computer system 102 can also generate suggestions for refining the AI, models, and/or classifiers described herein. Additionally or alternatively, the backend computer system 102 can generate suggestions for refining rules and/or techniques for detecting cybersecurity events.

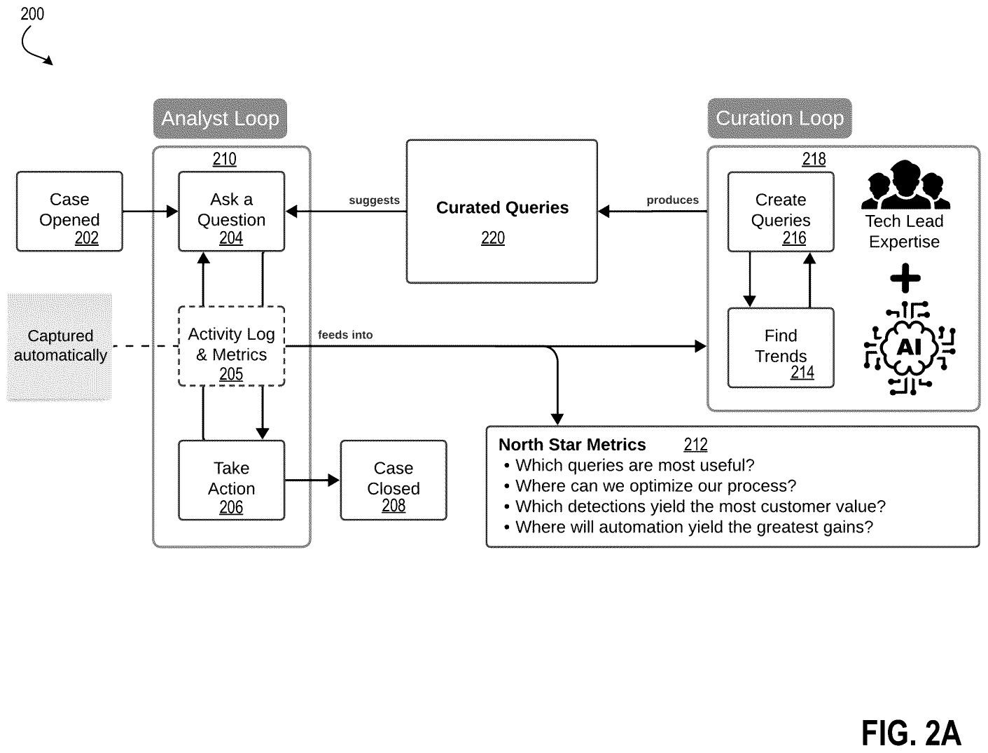

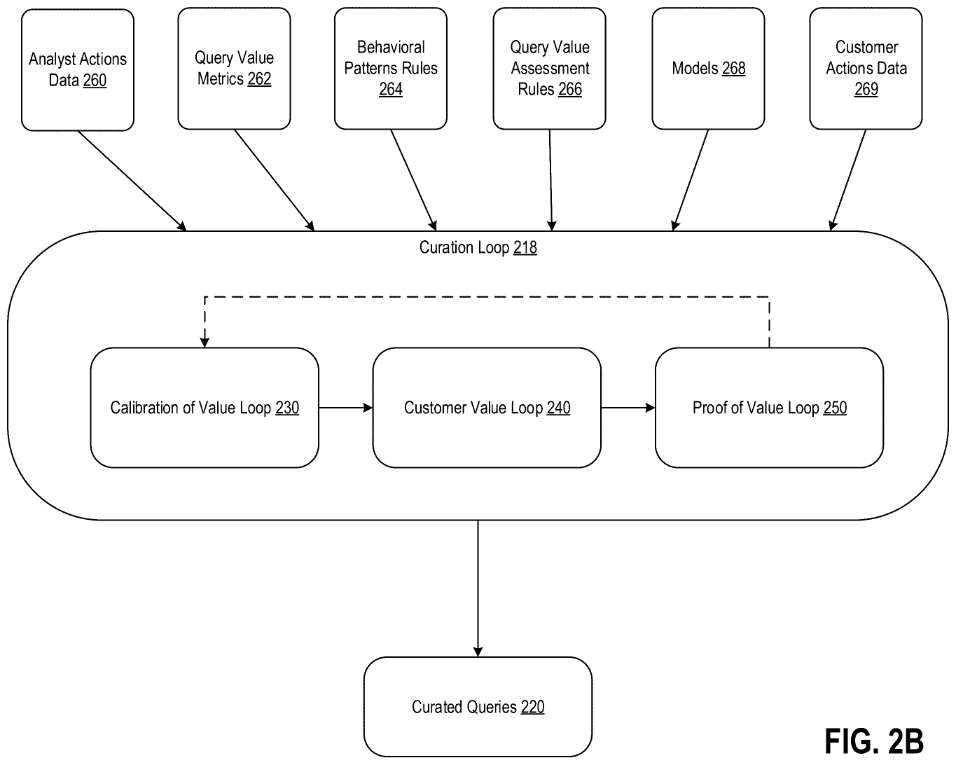

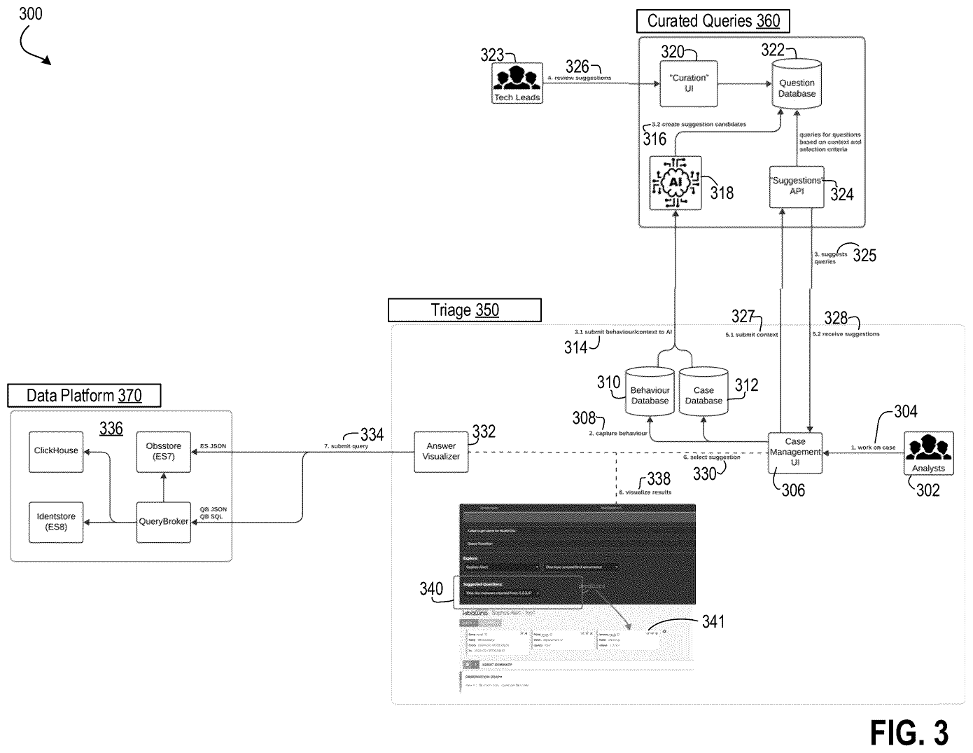

In some implementations, the backend computer system 102 can transmit the suggestions (e.g., refined queries) to computing devices of other relevant users, such as cybersecurity experts or other types of analysts. These computing devices can present the suggestions in one or more GUIs to allow for the relevant users to evaluate the suggestions for accuracy and/or validity. Sometimes, the relevant users can provide user input to modify the suggestions, which can then be fed back to the backend computer system 102 and used to improve the system 102's ability to identify behavior patterns, calculate query values, and/or generate the suggestions. In some implementations, the user input can be used by the system 102 to improve accuracy of its AI, models, and/or classifier. Refer to FIGS. 2A and 3 for further discussion about the role of the relevant users in evaluating the suggestions.

The suggestions can be transmitted to the analyst computing device 104 in block I (126) in one or more GUIs as described herein at the analyst computing device 104 (block J, 128). The suggestions can be presented in a GUI, as described further in reference to FIG. 5, during resolution of the particular cybersecurity event.

In some implementations, accuracy and/or usefulness of the suggestions can be evaluated through telemetry or similar techniques of tracking/recording actions performed at the analyst computing device 104 in response to presenting the suggestions. The techniques described herein can be performed in a loop such that the backend computer system 102 generates and provides refined queries through various stages of investigation and/or resolution of the current cybersecurity event being addressed by the analyst at the analyst computing device 104. Over time, looping through the operations described in FIG. 1 can further improve the backend computer system 102's ability to provide valued and accurate queries to the analyst through every step of investigation and resolution of a cybersecurity event.

FIG. 2A is a conceptual diagram of a process 200 having a feedback loop for generating curated queries in a cybersecurity environment. The process 200 can be performed to determine qualitative indicators of what cybersecurity events are big issues, critical, or otherwise important to customers. The process 200 can also be performed to determine qualitative indicators of what queries may provide the most value to assist analysts in resolving the cybersecurity events and addressing the concerns/asks of the customers. The feedback loop described in the process 200 can be used to improve queries over time for analysts in the cybersecurity environment. This is possible because costs and/or values associated with each query can be fed into the feedback loop as inputs and used to refine or otherwise improve the queries for future use/application to cybersecurity events. These costs can include but are not limited to an amount of time that an analyst spent investigating and/or resolving a cybersecurity event using the query or a set of queries. The values can include but are not limited to actual value that the query or set of queries may provide to resolution of the cybersecurity event, to the analyst's efficiency, and/or to the cybersecurity environment more generally.

Operations in the process 200 can be performed by one or more different users and/or computing systems. For example, as described herein, some operations of the process 200 can be performed at analyst computing devices, such as the analyst computing device 104 described in reference to FIG. 1. Some operations of the process 200 can be performed at the backend computer system 102 of FIG. 1. Yet some operations may be performed by computing devices of other relevant users, such as subject matter experts, customers, and/or other analysts in the cybersecurity environment.

Referring to the process 200 in FIG. 2A, a cybersecurity event case can be opened in block 202. For example, a customer can open the case or ticket using their computing device when they identify a potential cybersecurity event in their computing network/environment. In some implementations, the case can be automatically opened in response to cybersecurity infrastructure, which can be provided by the backend computer system 102, detecting or otherwise identifying the potential cybersecurity event in the computing network/environment of the customer. Once the case is opened, the case can be added to a queue of open cybersecurity event cases to be addressed by analysts in the cybersecurity environment. The case can include a variety of relevant data and information, such as: network traffic data that was detected or otherwise generated using the cybersecurity infrastructure; a pathway associated with the cybersecurity event; one or more timestamps indicating when the event was detected; other network traffic and/or user/customer actions that were performed around the same time that the event was detected; and other relevant information that may be used by the analysts to diagnose, investigate, and/or resolve the cybersecurity event. In some implementations, once the case is opened, it can be stored in a data store described herein and accessed at a later time for additional processing. Similarly, the case may include environmental metadata under which the cybersecurity event was found.

The case can be provided to the analyst computing device 104 of an analyst to perform an analyst loop 210. In the analyst loop 210, the analyst may work to resolve the case. In other implementations, once opened, the case can be transmitted to the backend computer system 102. The backend computer system 102 may perform pre-processing or initial processing of the data/information associated with the case, before transmitting the case to the analyst computing device 104. For example, the backend computer system 102 can perform processing to determine which analyst has a best skillset, expertise, and/or general availability to be assigned the case. The backend computer system 102 can apply one or more rulesets and/or criteria to determine the case assignment, then transmit the case to the device 104 of the assigned analyst.

In the analyst loop 210, the analyst may provide user input in one or more GUIs at the device 104 to ask one or more questions or queries (block 204). The analyst can select queries that have been previously determined and/or generated, such as by using the process 200 and other techniques described herein. Selecting the queries can cause components of the backend computer system 102 to execute the queries. Executing the queries can include providing responses or information back to the analyst in the GUIs.

Based on the information provided back to the analyst, the analyst can provide user input to take one or more actions to resolve the cybersecurity event (block 206). In some implementations, the customer may also take actions at their respective device, such as in response to the analyst performing actions in response to the queries asked in block 204. The customer actions may also be recorded in block 205 and transmitted to the backend computer system 102. The customer actions may be additional inputs in the curation loop 218, to glean insight and value into the actions and responses being performed by the analyst. In other words, the customer actions may be processed by the backend computer system 102 in the curation loop 218 to determine whether the customer is gleaning value from the analyst performing the actions in block 206.

While the analyst is asking questions/queries in block 204 and/or taking actions in block 206, the analyst computing device 104 can automatically capture or otherwise generate an activity log and/or metrics in block 205. Here, the GUIs loaded at the device 104 can track or otherwise record the analyst actions/behaviors using query handlers and/or UI inputs/interactions.

Sometimes, when the analyst takes actions in block 206, they can also provide user input to close the case in block 208. Closing the case can indicate that the cybersecurity event has been resolved. When the case is closed, information, such as a notification or report, can be transmitted to the computing device of the customer who opened the case in block 202. When the case is closed, relevant information about the analyst loop 210 (such as the recorded activity log and/or metrics) can be transmitted to the backend computer system 102 for further processing (e.g., refinement of query determinations, training and/or improving of AI, models, and/or classifiers). Additionally or alternatively, when the case is closed, relevant information about the analyst loop 210 can be transmitted to a data store for storage and later retrieval by the backend computer system 102 for processing at a later time.

The logged analyst actions/activity can be transmitted to the backend computer system 102, into a curation loop 218. In the curation loop 218, the backend computer system 102 can leverage AI, models, classifiers, algorithms, and/or rulesets to identify trends (block 214) and generate, refine, or otherwise create queries (block 216). One or more additional loops may be performed as part of the curation loop 218, as described further in reference to FIG. 2B.

To identify the trends in block 214, the backend computer system 102 can identify clusters of context for which the same behaviors and/or actions of the analyst are performed. AI, models, and/or classifiers can be trained and used to identify the trends in block 214. Identifying the trends in the process 200 is similar to blocks E (118) and/or F (120) in FIG. 1. Given the queries asked and actions taken in response to the case being opened in block 202, the backend computer system 102 can measure the value of the queries asked within the given context of the case, which may include but is not limited to measuring (e.g., quantitatively and/or qualitatively measuring) usefulness, cost, time spent, and/or inferring time wasted or well spent based on outcomes of the analyst's actions to the case being opened.

Using the identified trends, the backend computer system 102 may generate new suggestions, or queries, for the analyst to pursue when resolving the cybersecurity event case and/or other cases (block 216). Given the context of the case that is opened in block 202, and value determined by the backend computer system 102 in the curation loop 218, the backend computer system 102 can improve the quality of suggestions for the queries that are asked over time. For example, the backend computer system 102 can provide the captured analyst actions/behaviors and the trends/associated contexts as inputs to AI and/or machine learning models, which can be trained to identify patterns in cybersecurity events and/or the analyst actions to then create the new suggestions or queries. Using the identified trends, the backend computer system 102 may additionally or alternatively evaluate the quality of the new suggestions. Additionally or alternatively, the backend computer system 102 can refine existing suggestions and/or existing queries that may be used by the analyst.

Creating queries in block 216 can include determining value of questions/queries asked and actions taken by the analyst to identify most valuable questions/queries for cybersecurity events having a same or similar context. For example, the backend computer system 102 may infer severity or importance of a particular query. Severity or importance of the particular query can be inferred based on whether it results in actions being taken by the analyst (block 205, block 206). Severity of importance of the particular query can be inferred based on whether the particular query spurred additional cases or tickets to be opened and/or identified as related to the particular cybersecurity event. Sometimes, severity or importance of the particular query can be inferred based on whether the customer found the query and/or the analyst's resolution of the case to be important or otherwise relevant to them. As an illustrative example, the analyst may execute some queries to then close the case. Based on the queries, the backend computer system 102 may determine that there was no indicator of compromise. Although there was no indicator of compromise, the actions performed by the analyst may still be quantified by the backend computer system 102 as having high value (e.g., value above some predetermined threshold value) because the customer felt safe from the actions taken and/or the case was very important to them.

In some implementations, for each AI-generated suggestion or a subset of AI-generated suggestions, the backend computer system 102 can transmit the suggestion to a computing device of a subject matter expert, analyst, or other relevant user to review the associated context and provide an assessment of usefulness of the generated suggestion. This input from the subject matter expert can be transmitted back to the backend computer system 102 and fed into the curation loop 218 in order to automatically improve suggestions that are generated by the backend computer system 102 using the disclosed techniques.

The input from the subject matter expert can be used by the backend computer system 102 to rank the generated suggestions and/or select one or more of the suggestions to provide to the analyst at the analyst computing device 104 as curated queries in block 220. In some implementations, the backend computer system 102 can apply one or more AI, machine learning models, algorithms, rulesets, and/or criteria to ascertain quantitative value (e.g., usefulness) of the suggestions to the analyst. Suggestions that the backend computer system 102 identifies as having highest value, or value above a predetermined threshold value, level, and/or range, can be provided as curated queries in block 220 to the analyst computing device 104.

In some implementations, the backend computer system 102 can generate and/or refine queries in block 216 without using AI and/or machine learning models. Instead, the backend computer system 102 can use one or more rulesets to generate and/or refine the queries. The rulesets can be iteratively improved over time, such as being based on input provided by the subject matter experts described above. An exemplary rule can indicate that queries used more often than others, or queries that are used first in a set of queries asked during an investigation, can be refined and provided as curated queries in block 220.

The curated queries can be presented in the GUIs at the device 104 and used by the analyst to ask questions (block 204) as part of the analyst loop 210 for one or more other cybersecurity event cases. In other words, the suggestions that may be deemed useful based on the input from the subject matter expert can be presented to the analyst at the device 104 as the curated queries while the analyst is working on a cybersecurity event case having a same, similar, or otherwise matching context. The backend computer system 102 can determine case context and similarities amongst case contexts by using clustering techniques. In some implementations, the case context can be determined as part of identifying patterns and/or behavior patterns with respect to the cybersecurity event. The backend computer system 102 can determine whether a new cybersecurity event case has a same, similar, or matching context as the case that was opened in block 202. If the context is the same, similar, or matching, then the backend computer system 102 can provide the curated queries in block 220 as suggestions when the analyst asks questions in block 205 about the new cybersecurity event case.

The backend computer system 102 may also store the curated queries from block 220 in a data store, for later retrieval, use, and/or refinement. For example, whenever the backend computer system 102 detects a new cybersecurity event having a same, similar, or matching context, the backed computer system 102 can retrieve the stored curated queries and provide them as suggestions to the analyst computing device 104 when the analyst asks questions for addressing the event (block 204).

Any of the operations described above in the process 200 may also be repeated to continuously improve quality and/or value of suggestions that are generated over time by the backend computer system 102. Moreover, in some implementations, the backend computer system 102 can infer cross-customer cybersecurity threats and events. The process 200 may be customer-agnostic, meaning that queries that are curated and/or refined in the curation loop 218 in response to the particular cybersecurity event case opened in block 202 can also be applied or otherwise provided to analysts responding to other cybersecurity event cases, all of which may or may not be associated with the same customer. Sometimes, one or more customers may provide customer parameters to the backend computer system 102, which can be used by the backend computer system 102 to determine what curated queries should be provided to an analyst addressing a cybersecurity event case associated with the particular customer.

Referring back to logging the analyst actions/activity, sometimes the logged analyst actions/activity can be fed into metrics 212. The metrics 212 can be generated automatically by the backend computer system 102 and used as additional inputs to improve value and accuracy in refining and generating the curated queries in block 220. The metrics 212 can encompass various conditions, inquiries, and/or parameters, including but not limited to which queries are most useful, where can a process for resolving cybersecurity events be optimized, which detections yield most customer value or customer value above some threshold level of value, and/or where would automation of the process for resolving cybersecurity events yield greatest gains for the cybersecurity environment, the analyst, and/or the customer. Additionally or alternatively, the metrics 212 may encompass inquiries such as how long it took the analyst to close out one or more evidence tasks using timestamps, what decisions did the analyst make (as captured in the analyst loop 210), and/or what actions did customers take on their end (such as being captured in a customer loop with similar or same operations as the analyst loop 210 depicted in FIG. 2A).

In some implementations, the metrics 212 can be used by the backend computer system 102 in the curation loop 218 in order to cluster activity/actions data. The clustered data can then be processed by the backend computer system 102 to identify trends, determine value, and generate curated queries based on the trends and/or value (blocks 214 and 216). The data can be clustered in order to orient the analyst and other analysts in a same direction to build true customer values while also improving opportunities in the cybersecurity environment to optimize use of skills and expertise of the analysts. In some implementations, one or more of the metrics 212 can be defined by the analyst or a team of analysts and then used by the backend computer system 102 in the curation loop 218 to provide a view in aggregate as to business value being provided. The metrics 212, whether alone or in combination, can be used to validate determined value and/or suggested queries, reduce time needed by the analyst to resolve the cybersecurity event case, and/or improve overall analyst utilization.

FIG. 2B is a block diagram illustrating the curation loop 218 of FIG. 2A for generating curated queries as described herein. The curation loop 218 can be performed continuously and/or iteratively to identify value in queries and/or actions performed by analysts in response to cybersecurity events, and opportunities to optimize processes in a cybersecurity environment.

The curation loop 218, performed by the backend computer system 102, can receive a variety of inputs, including but not limited to analyst actions data 260, query value metrics 262, behavioral patterns rules 264, query value assessment rules 266, models 268, and/or customer actions data 269. The analyst actions data 260 can be the same as or similar to the actions data described in at least FIGS. 1 and 2A. The analyst actions data 260 can include queries asked by the analyst while investigating and/or resolving a cybersecurity event case. In some implementations, the analyst actions data 260 can include analysis history, which may include use of queries and/or actions. The query value metrics 262 can include any of the metrics 212 described further in reference to FIG. 2A. The behavioral patterns rules 264 can be any rules and/or criteria that may be used by the backend computer system 102 in the curation loop 218 to identify behavioral patterns of the analyst and glean insight/value from those patterns. The query value assessment rules 266 can include any rules and/or criteria that may be used by the backend computer system 102 to quantify value of queries that are identified from the analyst actions data 260, the query value metrics 262, the identified behavioral patterns, or any combination thereof. The models 268 may include any of the AI, models, algorithms, and/or classifiers described herein, which may be used to identify the behavior patterns, determine quantitative values of the queries performed by the analyst, and create/refine queries based on the patterns and the values of the queries. The customer actions data 269 can include outcomes from the customer, responses, or other actions performed by the customer in response to cybersecurity events associated with the customer being investigated, resolved, and/or closed. The customer actions data 269 can be used, as described further below, to glean insight into value for the customer and improving value delivered to the customer.

In the curation loop 218 one or more additional loops may be performed to accurately approximate or otherwise identify value. As a result of the processing performed by the additional loops 230, 240, and/or 250, the backend computer system 102 described herein can generate/output curated queries in block 220. The loops 230, 240, and/or 250 may loop on top of each other.

The calibration of value loop 230 can be performed as a first feedback loop in the curation loop 218. The loop 230 can be specific to calibrating value in terms of detection. For example, the backend computer system 102 can apply one or more rules, AI, and/or models in the loop 230 to determine whether techniques for detecting a particular cybersecurity event performed as expected and/or for their intended purposes. Outcomes from the determinations performed in the loop 230 can be converted to numeric values, where the numeric values indicate value of the detection techniques being performed in the cybersecurity environment.

The second feedback loop in the curation loop 218 can be the customer value loop 240. In the loop 240, the backend computer system 102 may apply one or more rules, AI, and/or models to determine whether customers are receiving value from the actions/detections performed in the cybersecurity environment. The backend computer system 102 can determine whether the customers are feeling comfortable and/or safe with the types of actions being performed by the analysts in the cybersecurity environment in response to the cybersecurity events. Outcomes from the determinations performed in the loop 240 can be converted to numeric values, where the numeric values indicate value to the customers.

The third feedback loop in the curation loop 218 can be the proof of value loop 250. In the loop 250, the backend computer system 102 may apply one or more rules, AI, and/or models to determine whether information and reporting provided to the customers is in fact valuable or useful to the customers. When a cybersecurity event is resolved, the backend computer system 102 can generate a report for the related customer, indicating how the event was resolved by the analysts in the cybersecurity environment. The related customer can provide feedback or other information in response to viewing/receiving the report. For example, the customer can provide feedback through a chatbot. The chatbot may include selectable/graphical elements such as a ‘thumbs up’ icon and a ‘thumbs down’ icon within the chatbot UI. The customer may also have additional opportunities to provide more feedback, such as written feedback and comments. The customer feedback can be provided to and processed by the backend computer system 102 to determine whether the appropriate, valuable information is being communicated to the customer.

The curation loop 218 as a whole can be performed to calibrate value against customer expectations and to educate the customers. As an illustrative example, a customer may misinterpret the value being delivered, which can cause the cybersecurity environment to engage more with the customer to help the customer understand and buy into the value behind the actions being performed in the cybersecurity environment to resolve the cybersecurity event. The curation loop 218 can additionally or alternatively be performed to calibrate value against customer expectations and to reevaluate how value is assessed in the cybersecurity environment. As an illustrative example, the cybersecurity environment may be providing the wrong value to customers in light of customer expectations.

The curation loop 218 can be performed in a variety of use cases to provide value. For example, the curation loop 218 can be used for ascertaining value in ticketing (e.g., case) outcomes. Each ticket that is opened for a customer can include an outcome that is taken by the customer along with an expected outcome from within the cybersecurity environment. The outcome of the customer can include taking action (e.g., the customer provides input indicating that the ticket identifies something of value to the customer). The outcome of the customer may include taking no action, such as the customer not caring about a potential cybersecurity event, or that the customer does not believe ticket was created for something valuable. Sometimes, the outcome can also include the customer agreeing to take action and not doing so. It can include an eventual security event that could have been mitigated had the customer taken the specific action. It may also include any other such future-looking outcomes based on these inputs.

As an illustrative example, the expected outcome can be the cybersecurity environment's perception of value, which may be different than the customer's perception of value. When these perceptions differ significantly and/or repeatedly, for example, the backend computer system 102 may perform the curation loop 218 in order to generate optimal suggestions for improving value and/or the perception of value. Example suggestions may include educating the customer and/or reevaluating how the cybersecurity environment defines value. In scenarios in which customer action aligns with delivery from the cybersecurity environment, the backend computer system 102 can confirm or validate the cybersecurity environment's perception of value. Based on the outcome from the customer, the backend computer system 102 may perform the curation loop 218 in order to reassess why the backend computer system 102 identified some action/event as valuable, educate based on the value, and/or reassess its definition of value.

As another example use case of providing value, the curation loop 218 can be performed to handle escalations. Escalations can oftentimes be misses in value or opportunity. In a scenario of a total miss, for example, the backend computer system 102 can reevaluate what is being delivered in the cybersecurity environment to customers. In a scenario of evidence closures, the backend computer system 102 may decide to close evidence without informing the customer so that the cybersecurity environment's perception of value may filter out results. In such a scenario, the backend computer system 102 may determine to educate the customer as to why the results were filtered out results (e.g., alter the customer's perception of value) and/or alter the cybersecurity environment's perception of value. Instead of filtering out the results, the backend computer system 102 may deliver those results to the customer.

As yet another example use case of providing value, the curation loop 218 can be performed to provide comprehensive reports and relevant information to the customer. Actions performed by the analysts can be presented in the reports based on what the backend computer system 102 identifies as valuable using the curation loop 218. Upon delivering the valuable information to the customer via reports and/or chatbots, the backend computer system 102 may receive feedback from the customer (e.g., UI features, a survey). The backend computer system 102 can process the user feedback to confirm the perception of value, or to identify gaps or opportunities for educating the customer about the perception of value. In some implementations, the user feedback can be processed by the backend computer system 102 to refine or otherwise alter the perception of value defined at the backend computer system 102 so that the perception of value aligns more with the customer's view on value.

The backend computer system 102 can process the user feedback to compute a ratio of value:cost from the customer perspective. The backend computer system 102 can compare the ratio of value:cost from the analyst perspective (described in reference to FIG. 1) with the ratio of value:cost from the customer perspective. For example, the backend computer system 102 can subtract the two ratios from each other and take a resulting absolute value to identify where the ratios are most divergent. Sorting queries based on their respective absolute values then prioritizing the queries having the most divergent rations can indicate where to focus efforts on educating and/or calibrating value from the analyst perspective, the customer perspective, or a combination thereof.

As another example use case of providing value, the curation loop 218 can be used to provide feedback on chatbot results. Information, as described in the above example, can be outputted in the chatbot to the customer. The chatbot can provide the customer with an opportunity to provide feedback, such as a rating of the chatbot and/or the information outputted in the chatbot. The feedback from the chatbot results can be another input into the curation loop 218.

FIG. 3 is a conceptual diagram of a system 300 for generating, presenting, and/or executing curated queries in a cybersecurity environment. The system 300 includes one or more components that may be similar to or the same as components described herein, such as the backend computer system 102 and/or the analyst computing device 104. The system 300 includes one or more additional components that may perform operations described herein.

The system 300 of FIG. 3 illustrates three phases of operations that can be performed to generate, present, and/or execute curated queries. These phases include a triage phase 350, a curated queries phase 360, and a data platform phase 370. In some implementations, the system 300 may include additional or fewer phases. Sometimes, one or more operations shown in one or more of the phases 350, 360, and 370 can be performed as part of other phases or a single phase. In brief, the triage phase 350 can be from an analyst 302 perspective, including operations such as the analyst 302 investigating a cybersecurity event case, performing actions in response, and selecting queries (e.g., suggested queries or curated queries) for execution. The curated queries phase 360 can be from the backend computer system 102 perspective, including operations such as identifying behavior patterns of the analyst 302 and generating or refining queries for use by the analyst 302. The data platform phase 370 can be from the perspective of an execution computing system, including operations such as executing the queries selected by the analyst 302.

Still referring to the system 300 in FIG. 3, the analyst can work on a cybersecurity event case in block 304 using a case management UI presented at the analyst's computing device (e.g., the analyst computing device 104) (block 306). Working on the case in block 304 can include performing actions to address the cybersecurity event in the case, such as asking queries. Any of the actions performed by the analyst 302 can be captured or otherwise recorded as the analyst 302's behavior in 308. Capturing the analyst 302's behavior can include storing the behavior in a behavior database 310. The behavior can be stored in association with an identifier for the analyst 302 and/or the particular case that the analyst 302 is working on. Additionally, data related to the particular case can be stored in a case database 312. The case data can include links (e.g., associations) to the captured behavior data. The case data can sometimes include context data. The context data may indicate a context of the particular cybersecurity event in the case. Sometimes, the context data may indicate the context of the actions and behaviors of the analyst 302 who resolves the particular cybersecurity event. As described herein, the context can evolve over time. An initial or exemplary context can target detection. A detection is an automated rule that can execute over customer data to determine whether or not a threat may be present. Exemplary detections may include, but are not limited to, 10+ DNS queries allowed to possibly malicious DNS tunneling VPN domains, anomaly detection alert, and/or high number of account lockouts. The context may be a proximate causal piece of evidence that may cause the detection to trigger. The context may evolve to include other features that can allow for improved prediction of class, set, and/or cluster of the particular cybersecurity event. The other/additional pieces of evidence may include, but are not limited to, results of queries that (i) are frequently performed on a given context, (ii) can be run before an analyst reviews the case, and/or (iii) can be shown to improve the class, set, and/or cluster of a given case. The context can sometimes be determined by a classifier, as described herein. In some implementations, the context can be provided as input to the classifier for use in determining value of a query and/or suggested improvements of the query.

The query suggestion candidates can be transmitted to a computing device of a technology lead 323, such as a subject matter expert or another analyst, using a curation UI 320. The query suggestion candidates can be presented in the curation UI 320 at the computing device so that the technology lead 323 can review the suggestions in 326. The technology lead 323 can provide input indicating which suggestions provide value and/or should be presented to the analyst 302 for use in addressing the present case and/or other/future cases.

In some implementations, once the analyst 302 begins working on the case in 304 and performs actions, a suggestions API 324 at the backend computer system 102 can be configured to poll the queries database 322 for queries to suggest to the analyst 302. For example, the suggestions API 324 can query the database 322 for questions/queries based on the context of the case and/or one or more selection criteria. One or more of the questions/queries that are queried using the API 324 can include queries that are identified and reviewed by the technology leads 323 in 326 as having value and/or being important/useful. The questions/queries that are queried using the API 324 can then be transmitted to the analyst 302's computing device in 325, and presented in the case management UI 306. The analyst 302 may select any one or more of those queries using features in the case management UI 306 to perform actions in response to the cybersecurity event.

Sometimes, the context data can be generated while the analyst 302 is performing actions in the case management UI 306, then submitted or transmitted to the suggestions API 324 in 327. The suggestions API 324 can then query the =queries database 322 as described above to identify and return query suggestions to the case management UI 306.

Once query suggestions are presented to the analyst 302 in the case management UI 306, the analyst 302 may select a suggested query to execute in 330. Selecting the suggested query can cause the case management UI 306 to present an answer visualizer 332 at the analyst 302's computing device. The answer visualizer 332 can provide answers in response to the selected query. Illustrative queries may include but are not limited to: “Have there been any <[this].EventName>events in the last 7 days?”, “Show me all events and observations related to <[this].process.parent.entity_id>.” The answer to the first illustrative query may be a Boolean value of yes/no. The answer to the second illustrative query may be a list of observations related to the process ID that was identified as a potential threat.

The analyst 302 may review the answers presented in the visualizer 332 to determine whether the selected query would produce an answer/results that the analyst 302 is looking for in order to resolve the cybersecurity event. If the analyst 302 approves of the answers presented in the visualizer 332, the analyst 302 can provide additional user input to submit the selected query for execution in 334.

Submitting the query in 334 includes transmitting instructions to execute the query to an execution computing system 336. The execution computing system 336 can include one or more illustrative components. For example, the system 336 may include a query broker. The query broker can include a computing system. Sometimes, the query broker can include a software module or engine. The query broker can be configured to route a selected query to a correct data store and/or processor. The execution system 336 may include that correct data store and/or processor/processing engine, such as CLICKHOUSE. Any other data store and/or processor/processing engine may be used.

Once the query is executed by the execution computing system 336, results from the execution can be provided back to the analyst 302's computing device. The results can be visualized or otherwise presented in 338 in one or more GUIs at the analyst 302's computing device. The visualized results in 338 can include a suggested queries field 340 and a results field 341. The analyst 302 may provide input at the suggested queries field 340 to toggle between different queries to select. In other words, the analyst 302 can select different queries in the suggested queries field 340 to repeat the operations described above. Whenever the selected query is executed by the execution computing system 336, the results field 341 can be automatically updated to include information or results related to the query execution.

In the illustrative example of FIGS. 3, 302, 304, 306, 308, 310, 312, 314, 327, 328, 330, 332, 338, 340, and 341 can be part of the triage phase 350. The curated queries phase 360 may include 316, 318, 320, 322, 323, 324, 326. The data platform phase 370 can include 334 and 336. Various other operations, processes, and/or components can be part of one or more of the phases 350, 360, and 370.

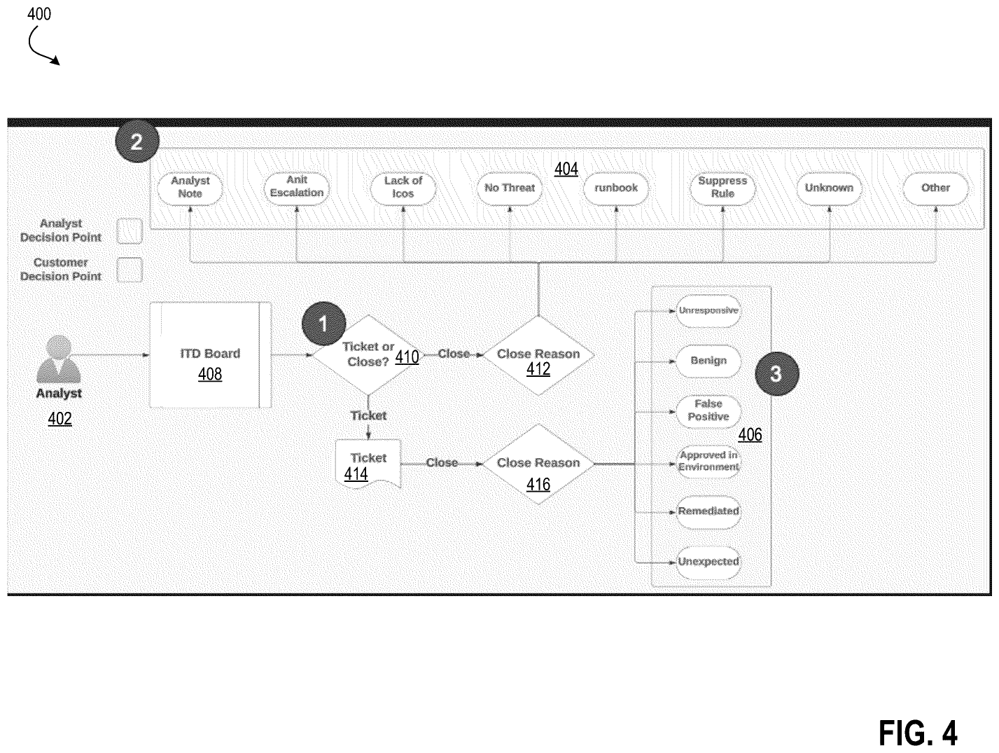

FIG. 4 is a conceptual diagram of a process 400 for responding to an evidence task in a cybersecurity environment. The process 400 is illustrative, and may not represent all activities performed by analysts when investigating and/or resolving the evidence task. Moreover, the process 400 is merely illustrative and can be applied to different use cases. The process 400 can be performed by an analyst 402 using a computing device of the analyst 402, such as the analyst computing device 102 described in FIGS. 1 and 2A.

In a typical investigation, the analyst 402 can make one or more decisions (e.g., perform actions, ask queries) on evidence tasks that are presented in their respective internal triage dashboard (ITD) board 408. The board 408 can be used by analysts, such as the analyst 402, to perform cybersecurity investigations as described herein. Each evidence task can be produced by a detection (e.g., a rule), which detected cybersecurity events, and is associated with a particular customer.

For example, for each evidence task presented in the board 408, the analyst 402 can decide whether to ticket or close the particular evidence task (block 410). The analyst 402 may ticket an evidence task even if it's not a task that may be worthy of reporting out to a customer (e.g., a ‘bragable’ event). For example, the analyst 402 may decide to ticket an evidence task for a restricted county login. While addressing and resolving this issue can be important to ensure proper login, the analyst 402 may not need to spend much time on it, if at all. In fact, ticketing this type of evidence task may indicate a gap in an understanding of value of an evidence task from the analyst 402's perspective because this type of evidence task may not be worthy of reporting to the customer or may not be worth the analyst 402's valuable time.

If the analyst 402 decides to close the particular evidence task, the analyst 402 may provide one or more close reasons 404 in block 412. The close reasons 404 may include but are not limited to an analyst note, escalation, lack of indicators of compromise (e.g., IoCs), no threat, runbook (e.g., the runbook can instruct the analyst to close the evidence task, which may indicate a waste of time and thus be something to tune out of the cybersecurity environment and/or automate so that the analyst does not have to address it), suppress rule, or other reasons. The close reasons (block 404) can be updated overtime to align with business outcomes, value, etc. Just like ticketing the evidence task may not be bragable (e.g., worthy of reporting out to the customer), closing may not be considered a waste of the analyst 402's time. Closed tasks may require thought and discernment on the part of the analyst 402. For example, a given evidence task may appear like suspicious POWERSHELL scripts being run in a customer's computer environment, but upon further examination, the analyst 402 may determine that this behavior is in fact expected. In this example, the task can be complex enough that it provides value to the customer for the analyst 402 to review, address, and close the task.

Sometimes a customer may decide to close a ticket. The close reasons (block 406) of the customer may include but are not limited to benign, false positive, approved in an environment, remediated, and/or unexpected. Various other close reasons (block 406) from the customer standpoint may also be determined and/or used. Sometimes, the customer may appreciate, or not appreciate, the actions performed by the analyst 402. Even if the customer resolves the ticket as being benign, the cybersecurity environment may not receive enough feedback from the customer indicating whether the analyst 402 has wasted the customer's time with the ticket or provided sufficient value to the customer. The customer's closure reason may not provide enough feedback indicating whether the customer appreciated that the analyst 402 spent the time, effort, and resources on investigating the ticket and/or that information about the closed ticket was provided to the customer.

Sometimes, feedback gaps may exist in the process 400, such as when the analyst 402 decides whether to ticket or close the evidence task in block 410, when the analyst 402 identifies one or more of the close reasons 404 in block 412, and/or when the customer identifies one or more of the close reasons 406 in block 416. One or more feedback gaps may exist for one or more of the close reasons 404 and/or 406, such as the lack of IoCs reason, the no threat reason, the false positive reason, the approved in the environment reason, and/or the remediated reason. In other words, these one or more of the close reasons 404 and/or 406 may be unmeasurable and/or challenging to align with value in the cybersecurity environment.

As shown by the process 400, one or more gaps may exist related to ticketing and closure for both the analyst 402 and the customer. The techniques described herein can be applied to the process 400 in order to identify where and whether analyst resources can be optimized and how value can be determined and/or improved from the perspective of both the analyst 402 and the customer so that high-value work (e.g., bragable events or work) is performed using the analyst resources and provided to the customer. In some implementations, the disclosed techniques can include adding UI features into the GUIs presented to the analyst 402 that enable the analyst 402 to provide input indicating whether the evidence task was valuable, whether it used more resources/time than preferred, and/or whether the evidence task was one of sufficient value to be reported to the customer (e.g., bragable). Using this type of input/feedback from the analyst 402, the disclosed techniques can be performed to separate closure reasons and ticket reasons from identifying valuable outcomes.

As another example, UI features can be provided into GUIs presented to the customer that enable the customer to provide input indicating whether reporting about the evidence task is liked, disliked, useful, valuable, etc. from the customer perspective. The feedback provided by the customer can be used with the disclosed techniques to quantitatively assess value being provided to the customer, whether the perception of value is accurate and/or can be optimized, and where there may be gaps in the process 400 in providing value to the customer. Refer to FIG. 2B for further discussion about incorporating the customer feedback into feedback loops for improving and/or optimizing value.

In some implementations, timestamps throughout the process 400 can provide valuable insights. For example, the timestamps can be measured from a time the analyst 402 looks at an evidence task to a time that the analyst 402 either tickets or closes the task. This timing information may be used with the disclosed techniques to quantitatively assess and calculate resources used by the analyst 402 (e.g., time, skills, brainpower) and to determine whether value can be derived from the analyst 402's actions throughout the process 400.

By integrating the disclosed techniques into the process 400, business outcomes and value can be determined/gleaned in the cybersecurity environment. The disclosed techniques can be applied to understand and quantify where and how the analyst 402 is spending time, and to align the analyst 402's use of time with value/bragability. Accordingly, the disclosed techniques may be used to identify tasks or actions that may be automated in the cybersecurity environment. Through automation, the analyst 402 can spend more time/brainpower on more valuable tasks. Moreover, the disclosed techniques can be used to identify and derive value from perspectives of the analyst 402, the customer, and/or the cybersecurity environment more generally.

FIG. 5 illustrates an example GUI 500 for presenting curated queries at an analyst computing device, such as the analyst computing device 104 described herein. The GUI 500 can present a table 502 for viewing one or more evidence tasks. In some implementations, the table 502 can present information for a particular or single evidence task. The table 502 can include information such as a field and a corresponding value for the evidence task. The fields and their corresponding values may include but are not limited to a timestamp, a type of evidence task, and/or an event path. Other information may also be presented in the table 502 for the evidence task.

The GUI 500 can also include a common questions portion 504. The portion 504 may present queries that are generated, refined, and/or curated using the disclosed techniques. As a result, the portion 504 can present queries that may be useful to the analyst in resolving the particular evidence task presented in the table 502. The queries presented in the portion 504 can be automatically updated over time as the analyst performs actions. The queries can be translated into their programmatic equivalents (e.g., SQL), thereby making it easier to understand what the query does, or to merge or augment the queries.

As described herein, the analyst may select one or more of the queries presented in the portion 504. In response to the analyst selection, the GUI 500 may present answers to the selected queries. The answers can be presented in a portion of the GUI 500 (not depicted)or in a pop-out window that overlays at least a portion of the GUI 500. Sometimes, when the analyst selects a query in the portion 504, the selected query can expand within the portion 504 to display the answer to the selected query. As described in reference to FIG. 3, selecting the query may also cause the query to be executed, resulting in actions being performed in response to the evidence task.

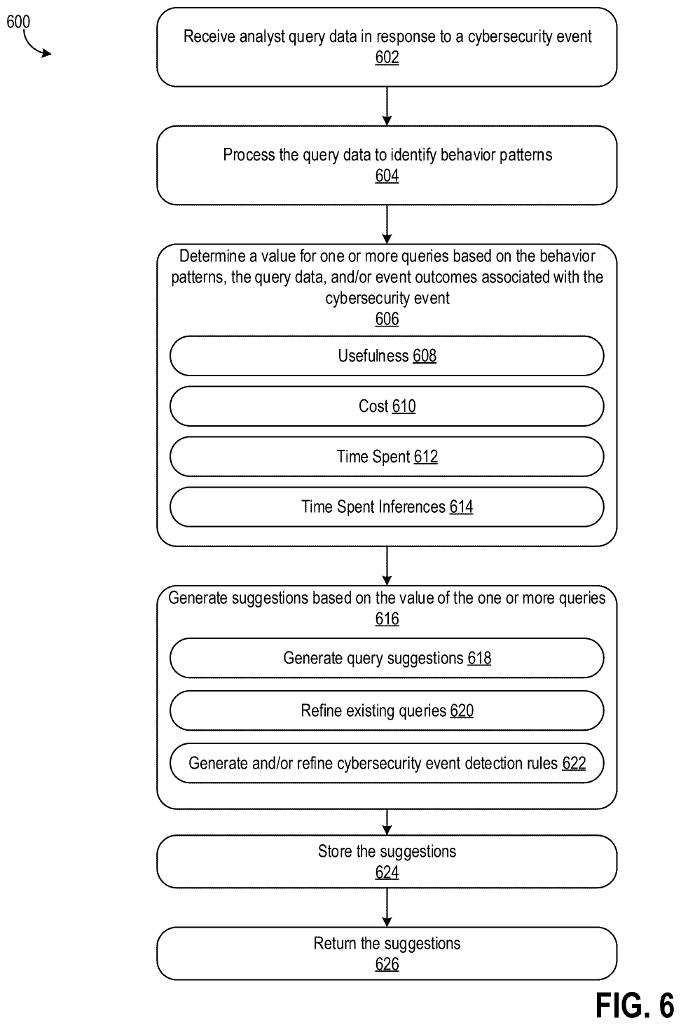

FIG. 6 is a flowchart of a process 600 for generating suggested queries in a cybersecurity environment. The process 600 can be performed by the backend computer system 102, or by one or more other computing systems, devices, computers, networks, cloud-based systems, and/or cloud-based services. For illustrative purposes, the process 600 is described from the perspective of a computer system.

Referring to the process 600 in FIG. 6, the computer system can receive analyst query data in response to a cybersecurity event in block 602. As described further in reference to blocks A (110) and B (112) in FIG. 1, an analyst can perform actions, such as asking queries, to respond to or otherwise address a particular cybersecurity event. These actions can be tracked/collected at the computing device, then transmitted to the computer system.

In block 604, the computer system can process the query data to identify behavior patterns of the analyst. As described further in reference to block E (118) in FIG. 1, the computer system can apply one or more AI, models, algorithms, and/or rules to identify the behavior patterns of the analyst in addressing the cybersecurity event. Such behavioral patterns can provide insight into a context of the cybersecurity event and/or how the analyst is spending their time, brainpower, and other resources.

The computer system may also determine a value for one or more queries based on the behavior patterns, the query data, and/or event outcomes associated with the cybersecurity event (block 606). For example, the value determined may include, but is not limited to, usefulness (block 608), cost (block 610), time spent (block 612), and/or time spent inferences (block 614). The computer system can calculate quantitative value for the queries performed by the analyst and/or queries that can be performed by the analyst in response to the cybersecurity event or similar cybersecurity events. Refer to at least block F (120) in FIG. 1 and FIGS. 2A, 2B, and 3 for further discussion about determining value.

Accordingly, the computer system can generate suggestions based on the value of the one or more queries in block 616. The computer system can generate query suggestions (block 618). The query suggestions may include new queries that may provide improved value to the analyst in resolving the cybersecurity event. Additionally or alternatively, the computer system can refine existing queries (bock 620). Generating and/or refining the queries can be based on the computer system determining a ratio of value:cost for each query. The computer system can then select one or more queries having respective ratios that trend towards 0 or are within a threshold range of 0. Additionally or alternatively, the computer system can generate and/or refine cybersecurity event detection rules (block 622). The computer system may, for example, generatethe detection rules to detect cybersecurity events having at least a threshold level of value to a particular customer, customers more generally, and/or the cybersecurity environment.

In blocks 616-622, generating the suggestions may sometimes include transmitting the suggestions to a computing device of a technology lead, subject matter expert, or other analyst. The technology lead may review the suggestions and determine whether they in fact provide a type of value desired to achieve business outcomes. Refer to at least FIG. 3 for further discussion. In some implementations, generating the suggestions may include ranking the suggestions based on their respective quantitative values. Refer to at least blocks G (122) and H (124) in FIG. 1 for further discussion.

The computer system may store the suggestions in block 624. The suggestions can be stored in a data store, as described in reference to FIG. 3. In some implementations, one or more other data/information described herein, such as data about the cybersecurity event, the actions performed by the analyst, the behavior patterns, and/or the determined value for the queries can also be stored in one or more data stores. Refer to FIG. 3 for further discussion. The stored information may be retrieved at a later time by the computer system and used for additional processing.

The computer system may also return the suggestions in block 626. One or more of the suggestions can be selected using one or more selection criteria and transmitted to the analyst's computing device. The selected suggestion(s) can be presented in GUIs, such as the GUI 500 described in reference to FIG. 5. Refer to blocks H (124), I (126), and J (128) in FIG. 1 and FIG. 3 for further discussion about selecting the suggestion(s) and returning the selected suggestion(s) to the analyst's computing device for review and/or execution. Sometimes, the suggestions can include recommended actions for a security analyst or other relevant user to take, such as queries to perform and/or response to take. Sometimes, the computer system can automatically perform one or more of the suggestions. For example, if the analyst does not implement the suggestion(s) and/or they don't respond in an expected way enough times, then the computer system may automatically implement the suggestion(s). This can, in some implementations, override any queries, actions, or responses that are performed by the analyst.

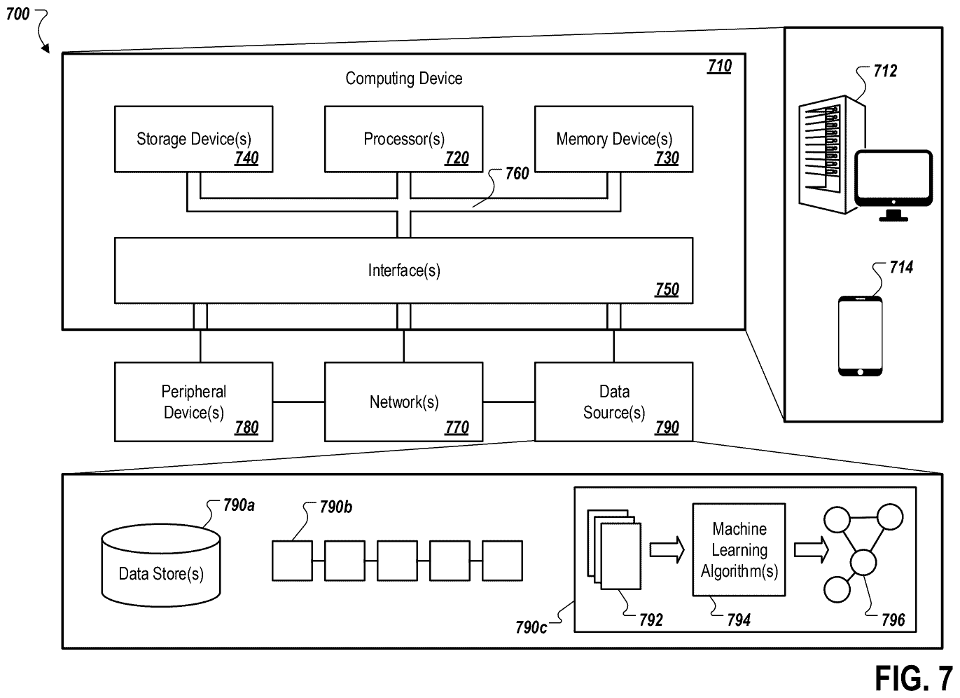

FIG. 7 is a schematic diagram that shows an example of a computing system 700 that can be used to implement the techniques described herein. The computing system 700 includes one or more computing devices (e.g., computing device 710), which can be in wired and/or wireless communication with various peripheral device(s) 780, data source(s) 790, and/or other computing devices (e.g., over network(s) 770). The computing device 710 can represent various forms of stationary computers 712 (e.g., workstations, kiosks, servers, mainframes, edge computing devices, quantum computers, etc.) and mobile computers 714 (e.g., laptops, tablets, mobile phones, personal digital assistants, wearable devices, etc.). In some implementations, the computing device 710 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 710, and an entire system can be made up of multiple devices communicating with each other. For example, the computing device 710 can be part of a computing system that includes a network of computing devices, such as a cloud-based computing system, a computing system in an internal network, or a computing system in another sort of shared network. Processors of the computing device (710) and other computing devices of a computing system can be optimized for different types of operations, secure computing tasks, etc. The components shown herein, and their functions, are meant to be examples, and are not meant to limit implementations of the technology described and/or claimed in this document.

The computing device 710 includes processor(s) 720, memory device(s) 730, storage device(s) 740, and interface(s) 750. Each of the processor(s) 720, the memory device(s) 730, the storage device(s) 740, and the interface(s) 750 are interconnected using a system bus 760. The processor(s) 720 are capable of processing instructions for execution within the computing device 710, and can include one or more single-threaded and/or multi-threaded processors. The processor(s) 720 are capable of processing instructions stored in the memory device(s) 730 and/or on the storage device(s) 740. The memory device(s) 730 can store data within the computing device 710, and can include one or more computer-readable media, volatile memory units, and/or non-volatile memory units. The storage device(s) 740 can provide mass storage for the computing device 710, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 750 can include various communications interfaces (e.g., USB, Near-Field Communication (NFC), Bluetooth, WiFi, Ethernet, wireless Ethernet, etc.) that can be coupled to the network(s) 770, peripheral device(s) 780, and/or data source(s) 790 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 750 can include a control interface that receives commands from an input device (e.g., operated by a user) and converts the commands for submission to the processors 720. The interface(s) 750 can include a display interface that includes circuitry for driving a display to present visual information to a user. The interface(s) 750 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 770 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 710 can communicate with the peripheral device(s) 780, the data source(s) 790, and/or other computing devices over the network(s) 770. In some implementations, the computing device 710 can directly communicate with the peripheral device(s) 780, the data source(s), and/or other computing devices.

The peripheral device(s) 780 can provide input/output operations for the computing device 710. Input devices (e.g., keyboards, pointing devices, touchscreens, microphones, cameras, scanners, sensors, etc.) can provide input to the computing device 710 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 710 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 790 can provide data for use by the computing device 710, and/or can maintain data that has been generated by the computing device 710 and/or other devices (e.g., data collected from sensor devices, data aggregated from various different data repositories, etc.). In some implementations, one or more data sources can be hosted by the computing device 710 (e.g., using the storage device(s) 740). In some implementations, one or more data sources can be hosted by a different computing device. Data can be provided by the data source(s) 790 in response to a request for data from the computing device 710 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 790a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 790b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 790c. The machine learning system(s) 790c, for example, can be used to analyze data from various sources (e.g., data provided by the computing device 710, data from the data store(s) 790a, data from the blockchain(s) 790b, and/or data from other data sources), to identify patterns in the data, and to draw inferences from the data patterns. In general, training data 792 can be provided to one or more machine learning algorithms 794, and the machine learning algorithm(s) can generate a machine learning model 796. Execution of the machine learning algorithm(s) can be performed by the computing device 710, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for fine-tuning a cybersecurity event response, the method comprising:
receiving, by a computer system, analysis history data associated with the cybersecurity event response and a security outcome of user actions performed in the cybersecurity event response;
identifying, by the computer system, behavior patterns based on the analysis history data;
generating, by the computer system, a value for the cybersecurity event response, wherein the value corresponds to the security outcome of the user actions performed in the cybersecurity event response and the identified behavior patterns;
determining, by the computer system, at least one suggestion for fine-tuning the cybersecurity event response based on the value for the cybersecurity event response; and
returning, by the computer system, the at least one suggestion for fine-tuning the cybersecurity event response.

2. The method of claim 1, wherein the at least one suggestion comprises a recommendation for refining an immediate next action to take in response to a cybersecurity event.

3. The method of claim 1, wherein the at least one suggestion comprises a recommendation for refining one or more queries that are used to investigate context around a cybersecurity event.

4. The method of claim 1, wherein the at least one suggestion comprises a recommended response for addressing a cybersecurity event.

5. The method of claim 1, wherein the analysis history data comprises queries that were executed in response to investigating one or more cybersecurity events.

6. The method of claim 1, wherein generating, by the computer system, the value for the cybersecurity event response comprises applying artificial intelligence (AI) techniques to the security outcome of the user actions and the identified behavior patterns, wherein the AI techniques are trained to correlate the security outcome, the user actions, and the behavior patterns to determine numerical values of one or more actions in the cybersecurity event response that correspond to the value for the cybersecurity event response.

7. The method of claim 1, wherein determining, by the computer system, the at least one suggestion for fine-tuning the cybersecurity event response comprises applying AI techniques to the determined value to generate the at least one suggestion, wherein the AI techniques are trained to correlate the determined value for the cybersecurity event response with actions in the cybersecurity event response to generate the at least one suggestion that, when executed in response to a cybersecurity event, maintains or improves the determined value for the cybersecurity event response.

8. A method for generating suggestions in a cybersecurity environment, the method comprising:
receiving, by a computer system, an indication of compromise in a computer network;
receiving, by the computer system and based on the indication of compromise, analysis history data of responses to the indication of compromise, wherein the analysis history data comprises queries that were executed to respond to the indication of compromise;
determining, by the computer system and based on processing the analysis history data and the indication of compromise, a value of the queries;
generating, by the computer system and based on (i) the value of the queries and (ii) a context of a cybersecurity risk associated with the indication of compromise, one or more cybersecurity response suggestions; and
returning, by the computer system, the one or more cybersecurity response suggestions.

9. The method of claim 8, wherein the indication of compromise comprises environmental metadata under which the cybersecurity risk was detected in the computer network.

10. The method of claim 8, wherein the value of the queries is determined, by the computer system, within a context of a detected cybersecurity risk that is associated with the indication of compromise.

11. The method of claim 8, wherein determining, by the computer system and based on processing the analysis history data and the indication of compromise, the value of the queries further comprises measuring a usefulness of the queries based on a security outcome from executing the queries.

12. The method of claim 8, wherein determining, by the computer system and based on processing the analysis history data and the indication of compromise, the value of the queries further comprises measuring a cost of the queries based on a security outcome from executing the queries.

13. The method of claim 8, wherein determining, by the computer system and based on processing the analysis history data and the indication of compromise, the value of the queries further comprises measuring time spent on the queries based on a security outcome from executing the queries.

14. The method of claim 8, wherein determining, by the computer system and based on processing the analysis history data and the indication of compromise, the value of the queries comprises inferring time spent on the queries based on a security outcome from executing the queries.

15. A method for generating query suggestions in a cybersecurity environment, the method comprising:
collecting, by a computer system, analyst actions, queries executed, and security outcomes within a context of an indication of compromise in a computer network;
calculating, by the computer system, a value of each of the queries based on processing the analyst actions and the security outcomes;
ranking, by the computer system, the queries based on the calculated value for each of the queries;
generating, by the computer system and based on the ranking, suggestions for improving the queries; and
returning, by the computer system, the suggestions for execution.

16. The method of claim 15, wherein calculating, by the computer system, the value of each of the queries further comprises applying AI techniques to the analyst actions and the security outcomes, wherein the AI techniques are trained to correlate the analyst actions and the security outcomes with numerical values that indicate a quantitative value associated with each of the queries that corresponds to an improved security outcome.

17. The method of claim 15, wherein the queries are ranked from highest value to lowest value, wherein the highest value indicates a query needing most improvement and the lowest value indicates a query needing least improvement amongst the queries.

18. The method of claim 15, wherein the suggestions comprise queries to be asked or executed in response to subsequent cybersecurity events.

19. The method of claim 15, further comprising returning the suggestions for presentation in a user interface (UI) at a computing device.

20. The method of claim 15, wherein the analyst actions comprise actions performed by an analyst using UI features presented at a computing device for responding to a cybersecurity event in the computer network.
